(19) United States
(12) Patent Application Publication
(10) Pub. No.: US 2008/0236915 A1
(43) Pub. Date: Oct. 2, 2008

(54) Hybrid drive train of a motor vehicle and method for controlling a hybrid drive train

(75) Inventors: Bernd-Guido Schulze, Wolfsburg (DE); Markus Henke, Wolfsburg (DE); Sven Martin, Wolfsburg (DE)

Correspondence Address: MANFRED BECK, P.A., 830 TYLER STREET, HOLLYWOOD, FL, 33019-1327, US

(73) Assignee: Volkswagen Aktiengesellschaft, Wolfsburg (DE)

(21) Appl. No.: 12/056,468

(22) Filed: Mar. 27, 2008

Related U.S. Application Data
(63) Continuation of application No. PCT/EP2006/008343, filed on Aug. 25, 2006.

(30) Foreign Application Priority Data
Sep. 28, 2005 (DE) 10 2005 046 533.1

(51) Int. Cl. B60K 6/20; G06F 19/00

(52) U.S. Cl. 180/65.4; 701/22

(57) ABSTRACT

A hybrid drive train includes an internal combustion engine, an electromagnetic transmission downstream of the internal combustion engine and an axle drive downstream of the electromagnetic transmission. The electromagnetic transmission includes a first and a second electric machine and a stator in common for the first and the second electric machine. The first electric machine has a drive rotor connected to an input shaft. The second electric machine has an output drive rotor connected to an output shaft. An effective transmission ratio can be set by an axial displacement of the stator in relation to the drive rotor and the output drive rotor. A driving battery is connected to a short-circuit winding of the stator via switchable lines and power electronics having an associated controllable DC-DC converter, so that a flow of energy between the first and second electric machines and the driving battery can be controlled.

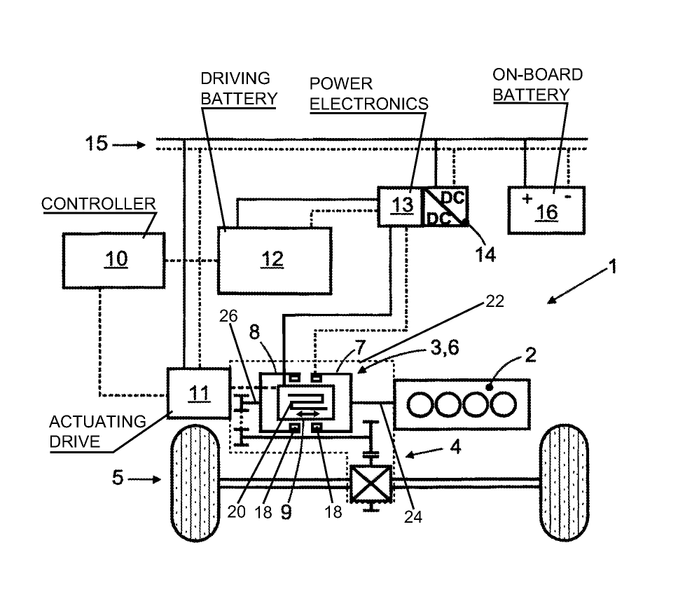

### CROSS-REFERENCE TO RELATED APPLICATIONS

This application is a continuation, under 35 U.S.C. § 120, of copending International Application No. PCT/EP2006/008343, filed Aug. 25, 2006, which designated the United States; this application also claims the priority, under 35 U.S.C. § 119, of German Patent Application No. DE 10 2005 046 533.1, filed Sep. 28, 2005; the prior applications are herewith incorporated by reference in their entirety.

### BACKGROUND OF THE INVENTION

### Field of the Invention

The invention relates to a hybrid drive train of a motor vehicle, with a series arrangement of an internal combustion engine, a first electric machine which can be operated predominantly as a generator, a second electric machine which can be operated predominantly as an electric motor, and an axle drive. The hybrid drive train includes a driving battery, which can be connected to the two electric machines via switchable lines and power electronics, and a controller for controlling the flow of energy between the electric machines and the driving battery. The invention also relates to a method for controlling a hybrid drive train.

A hybrid drive train of a motor vehicle is understood to be a drive train with a hybrid drive which includes a combination of an internal combustion engine and an electric motor, it being possible for the electric motor to be supplied with power either by an accompanying driving battery or via current collectors from a contact wire. A distinction is drawn between a series and a parallel hybrid drive in accordance with the drive arrangement of the internal combustion engine and the electric motor.

In a parallel hybrid drive, which is known, for example, from German Patent Application Publication No. DE 102 48 715 A1 and corresponding U.S. Patent Application Publication No. 2006/096795 A1 and from German Patent No. DE 101 58 536 B4 and corresponding U.S. Pat. No. 6,808,470 B2, the internal combustion engine and the electric motor are arranged in parallel and act on the axle drive, that is to say the motor vehicle in question can selectively be driven directly by the internal combustion engine or the electric motor or jointly by the two drive motors. However, a disadvantage of this design is that a starting clutch and a drive transmission are required for drive-away and driving operation using the internal combustion engine, and this results in a large installation space requirement and a high weight of the drive train.

In a series hybrid drive in contrast, the internal combustion engine drives a generator through the use of which an electric motor, which is connected to the axle drive, is fed in conjunction with a driving battery. The motor vehicle is therefore always directly driven by the electric motor, it being possible, however, for the internal combustion engine to be turned off as required, for example when driving in inner-city areas with emission controls, so that the electric motor is then fed only by the driving battery. An advantage of this design is that a starting clutch and a drive transmission are not required and can be saved, this resulting in a low installation space requirement and a low weight of the drive train. However, a disadvantage of this design is the double mechanical/electrical and electrical/mechanical energy conversion between the internal combustion engine, the generator and the electric motor, which results in a relatively poor degree of efficiency. Furthermore, the electric motor is usually operated in an unfavorable operating range at relatively high driving speeds.

### SUMMARY OF THE INVENTION

It is accordingly an object of the invention to provide a hybrid drive train which overcomes the above-mentioned disadvantages of the heretofore-known hybrid drive trains of this general type and which has an improved degree of efficiency together with compact dimensions. Another object of the invention is to provide a method for controlling a hybrid drive train according to the invention.

With the foregoing and other objects in view there is provided, in accordance with the invention, a hybrid drive train including:

an internal combustion engine;

an electromagnetic transmission connected downstream of the internal combustion engine;

an axle drive connected downstream of the electromagnetic transmission;

the electromagnetic transmission including a housing, a first electric machine disposed in the housing, a second electric machine disposed in the housing, and a stator provided in common for the first electric machine and the second electric machine;

the first electric machine having a rotatably mounted drive rotor connected to an input shaft and being operable predominantly as a generator;

the second electric machine having a rotatably mounted output drive rotor connected to an output shaft, the second electric machine being connected downstream of the first electric machine and being operable predominantly as an electric motor;

the drive rotor and the output drive rotor having, axially adjacent to one another, in each case permanent magnets of alternately opposite polarity distributed circumferentially to form a cylindrical arrangement;

the stator having at least one short-circuit winding disposed radially adjacent to the permanent magnets of the drive rotor and the output drive rotor;

the stator being connected in a rotationally fixed manner to a housing component and mounted in an axially displaceable manner, so that an effective transmission ratio can be set by an axial displacement of the stator in relation to the drive rotor and the output drive rotor; and

a driving battery connected to the short-circuit winding via switchable lines and power electronics having an associated controllable DC-DC converter, so that a flow of energy between the first and second electric machines and the driving battery can be controlled by a controller.

In other words, according to the invention, there is provided a drive train of a motor vehicle having a series arrangement including:

an internal combustion engine which interacts with an electric motor to form a hybrid drive;

an electromagnetic transmission which is connected downstream of the internal combustion engine; and

an axle drive which is connected downstream of the electromagnetic transmission;

wherein the electromagnetic transmission includes a first electric machine, which can be operated predominantly as a generator, the first electric machine being arranged in a housing and having a rotatably mounted drive rotor which is connected to an input shaft, and wherein the electromagnetic transmission includes a second electric machine, which is connected downstream of the first electric machine, the second electric machine being operable predominantly as an electric motor and being arranged in the same housing and having a rotatably mounted output drive rotor which is connected to the output shaft, with the drive rotor and the output drive rotor having, axially adjacent and in a cylindrical arrangement, permanent magnets of alternating polarity which are in each case distributed over the circumference, wherein the electromagnetic transmission further includes a stator which is common to the two electric machines, the stator having at least one short-circuit winding in a radially adjacent arrangement to the permanent magnets of the two rotors, the stator being connected in a rotationally fixed manner to a housing component and being mounted in an axially displaceable manner, so that an effective transmission ratio can be set by an axial displacement of the stator in relation to the rotors and wherein a driving battery is connected to the short-circuit winding via switchable lines and power electronics which have an associated controllable DC-DC converter, so that a flow of energy between the electric machines and the driving battery can be controlled by a controller.

According to another feature of the invention, the driving battery is connected to an on-board electrical system and an on-board battery via the controllable DC-DC converter.

According to a further feature of the invention, a further drivable axle with an associated electric motor is provided, wherein the electric motor can be connected to the driving battery and/or the short-circuit winding of the stator as required.

With the objects of the invention in view there is also provided, a method for controlling a drive train that includes the steps of:

providing a hybrid drive train having an internal combustion engine, an electromagnetic transmission downstream of the internal combustion engine and an axle drive downstream of the electromagnetic transmission, the electromagnetic transmission including a housing, a first electric machine disposed in the housing, a second electric machine disposed in the housing, and a stator provided in common for the first electric machine and the second electric machine, the first electric machine having a rotatably mounted drive rotor connected to an input shaft and being operable predominantly as a generator, the second electric machine having a rotatably mounted output drive rotor connected to an output shaft, the second electric machine being connected downstream of the first electric machine and being operable predominantly as an electric motor, the drive rotor and the output drive rotor having, axially adjacent to one another, in each case permanent magnets of alternately opposite polarity distributed circumferentially to form a cylindrical arrangement, the stator having at least one short-circuit winding disposed radially adjacent to the permanent magnets of the drive rotor and the output drive rotor, the stator being connected in a rotationally fixed manner to a housing component and mounted in an axially displaceable manner, so that an effective transmission ratio can be set by an axial displacement of the stator in relation to the drive rotor and the output drive rotor;

providing a driving battery connected to the short-circuit winding via switchable lines and power electronics having an associated controllable DC-DC converter;

controlling a flow of energy between the first and second electric machines and the driving battery with a controller;

displacing the stator fully into or onto the drive rotor and operating the drive rotor in conjunction with the short-circuit winding as an electric motor for an electric starting of the internal combustion engine at a vehicle standstill.

In other words, according to the invention, there is provided a method for controlling a hybrid drive train as defined above, wherein, for an electric starting of the internal combustion engine when the vehicle is at a standstill, the stator is displaced fully into or onto the drive rotor (i.e. fully towards the drive rotor), and the drive rotor is operated in conjunction with the short-circuit winding as an electric motor.

Another mode of the invention includes initially placing the stator fully into or onto the drive rotor and subsequently displacing the stator in a direction towards the output drive rotor in order to drive off from a vehicle standstill, wherein the drive rotor is operated in conjunction with the short-circuit winding as a generator and the output drive rotor is operated in conjunction with the short-circuit winding as an electric motor.

Another mode of the invention includes feeding energy from the driving battery to the short-circuit winding for boosting or for raising a load point of the internal combustion engine; and displacing the stator in a direction towards the drive rotor in order to compensate a thus changed transmission ratio of the electromagnetic transmission.

Another mode of the invention includes feeding energy from the short-circuit winding to the driving battery for recuperating or for lowering a load point of the internal combustion engine; and displacing the stator in a direction towards the output drive rotor in order to compensate a thus changed transmission ratio of the electromagnetic transmission.

Another mode of the invention includes displacing the stator fully into or onto the output drive rotor for driving electrically when the internal combustion engine is turned off; and subsequently operating the output drive rotor in conjunction with the short-circuit winding as an electric motor.

Another mode of the invention includes charging the on-board battery via the controllable DC-DC converter as required from the driving battery or the short-circuit winding of the stator.

Another mode of the invention includes connecting the driving battery to an on-board electrical system and an on-board battery via the controllable DC-DC converter.

Another mode of the invention includes connecting an electric motor associated with a further drivable axle or axle drive to the driving battery and/or the short-circuit winding of the stator as required.

By combining the electromagnetic transmission, which is known as an infinitely variable transmission for example from German Patent No. DE 44 08 719 C1 and corresponding U.S. Pat. No. 5,675,203 and from German Patent Application Publication No. DE 101 63 226 A1, with an internal combustion engine, a driving battery and power electronics, a powerful hybrid drive train is formed which has an improved degree of efficiency on account of its extended control options in comparison to conventional parallel hybrid drive trains. The hybrid drive train according to the invention can carry out all known hybrid functions, for example boosting, recuperation, load point increase or load point reduction, start/stop operation, periodic acceleration and coasting, electric starting of the internal combustion engine and electric driving, on the one hand by adjusting the stator and, on the other hand, by an energy supply or energy discharge between the short-circuit winding and the driving battery.

The electromagnetic transmission that is used can, as is known from German Patent No. DE 44 08 719 C1 and corresponding U.S. Pat. No. 5,675,203 and from German Patent Application Publication No. DE 101 63 226 A1, be in the form of an external rotor in which the stator is arranged radially on the inside, the short-circuit winding is arranged radially outside on the stator, the drive rotor and the output drive rotor are arranged radially on the outside, and the permanent magnets are arranged on the radial inner face, which faces the short-circuit winding, on the rotors. However, the electromagnetic transmission in question may also be in the form of an internal rotor with a radially outer stator and with radially inner rotors, in which the short-circuit winding is arranged radially inside on the stator and the permanent magnets are arranged on the radial outer face, which faces the short-circuit winding, on the rotors.

Since voltages and currents of different magnitudes and pulse frequencies occur as a function of the rotation speed of the drive, that is to say the rotation speed of the internal combustion engine, and the axial position of the stator in the short-circuit winding, the driving battery is expediently connected to the short-circuit winding of the stator via a controllable DC-DC converter.

In order to limit the line losses or power losses and in order to limit the physical size, the driving battery usually has a higher voltage level than the on-board electrical system and the on-board battery with the usual 12 volts. It is therefore advantageous if the vehicle battery is connected to the on-board electrical system and the on-board battery through the use of a controllable DC-DC converter. As a result, the on-board battery can be charged by the driving battery as required, and a separate generator for the on-board electrical system can be saved.

In order to implement all-wheel drive, which can be switched on, a further drivable axle with an associated electric motor can be provided, it being possible for the electric motor to be connected to the driving battery and/or the short-circuit winding of the stator as required. The further drive axle can be connected or engaged, for example, as a function of the traction of the main drive axle.

The hybrid drive train according to the invention can be used for electric starting of the internal combustion engine when the vehicle is stationary at a standstill by the stator being displaced fully into or onto the drive rotor, and the drive rotor being operated in conjunction with the short-circuit winding as an electric motor.

In order to drive off from when the vehicle is at a standstill, the stator is initially placed fully into or onto the drive rotor and then displaced in the direction towards the output drive rotor, with the drive rotor being operated in conjunction with the short-circuit winding as a generator and the output drive rotor being operated in conjunction with the short-circuit winding as an electric motor.

In order to boost or to raise the load point of the internal combustion engine, energy is fed to the short-circuit winding from the driving battery, it being possible for the stator to be displaced in the direction of the drive rotor in order to compensate the thus changed transmission ratio of the electromagnetic transmission.

In order to recuperate or lower the load point of the internal combustion engine, energy is fed to the driving battery from the short-circuit winding, it being possible for the stator to be displaced in the direction of the output drive rotor in order to compensate the thus changed transmission ratio of the electromagnetic transmission.

For electric driving when the internal combustion engine is turned off, the stator is displaced fully into or onto the output drive rotor and the output drive rotor is then operated in conjunction with the short-circuit winding as an electric motor.

Other features which are considered as characteristic for the invention are set forth in the appended claims.

Although the invention is illustrated and described herein as embodied in a hybrid drive train of a vehicle and a method for controlling a hybrid drive train, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The single FIGURE is a schematic view of the structure of a hybrid drive train according to the invention.

### DESCRIPTION OF THE PREFERRED EMBODIMENTS

Referring now to the single FIGURE, there is shown a hybrid drive train 1 which has a series arrangement including an internal combustion engine 2, an electric machine 3, and an axle drive 4 of a drive axle 5. The electric machine 3 is embodied as an electromagnetic transmission 6 with a drive rotor 7, an output drive rotor 8 and a stator 9 which is mounted in a rotationally fixed and axially displaceable manner. The rotors 7, 8 are in each case provided with permanent magnets 18 of alternating polarity which are arranged distributed over the circumference. The stator 9 has at least one short-circuit winding 20 which runs axially and over the circumference and interacts in an electromagnetic manner with the permanent magnets 18 when the rotors 7, 8 rotate. The electromagnetic transmission 6 therefore constitutes a combination of a generator and an electric motor. The electromagnetic transmission 6 has a housing which is only schematically indicated by a dashed line 22. The drive rotor 7 is connected to an input shaft 24 whereas the output drive rotor 8 is connected to an output shaft 26.

In order to control the various operating functions of the hybrid drive train 1, a controller 10, inter alia for adjusting the axial position of the stator 9, is connected to an associated actuating drive 11 and, for detecting the charge state of a driving battery 12, the controller 10 is connected to the driving battery 12. The driving battery 12 is, in turn, connected both to the short-circuit winding 20, which is arranged on the stator 9, and to the on-board electrical system 15 or the on-board battery 16 via electrical lines and power electronics 13 which have at least one associated DC-DC converter 14.

Typical hybrid functions, such as boosting, recuperation and load point increase or reduction of the internal combustion engine, are possible on account of the connection, which can largely be switched and controlled as desired, of the driving battery 12 to the short-circuit winding 20 of the electromagnetic transmission 6 by the controlled interchange of energy. The combination of the electromagnetic transmission 6 with the driving battery 12 and the power electronics 13 therefore forms a complete hybrid drive.

Due to the connection of the driving battery 12 to the on-board electrical system 15, the on-board battery 16 can be charged as required, without an additional generator.

What is claimed is:

1. A hybrid drive train comprising:
an internal combustion engine;
an electromagnetic transmission connected downstream of said internal combustion engine;
an axle drive connected downstream of said electromagnetic transmission;
said electromagnetic transmission including a housing, a first electric machine disposed in said housing, a second electric machine disposed in said housing, and a stator provided in common for said first electric machine and said second electric machine;
said first electric machine having a rotatably mounted drive rotor connected to an input shaft and being operable predominantly as a generator;
said second electric machine having a rotatably mounted output drive rotor connected to an output shaft, said second electric machine being connected downstream of said first electric machine and being operable predominantly as an electric motor;
said drive rotor and said output drive rotor having, axially adjacent to one another, in each case permanent magnets of alternately opposite polarity distributed circumferentially to form a cylindrical arrangement;
said stator having at least one short-circuit winding disposed radially adjacent to said permanent magnets of said drive rotor and said output drive rotor;
said stator being connected in a rotationally fixed manner to a housing component and mounted in an axially displaceable manner, so that an effective transmission ratio can be set by an axial displacement of said stator in relation to said drive rotor and said output drive rotor; and
a driving battery connected to said short-circuit winding via switchable lines and power electronics having an associated controllable DC-DC converter, so that a flow of energy between said first and second electric machines and said driving battery can be controlled by a controller.

2. The hybrid drive train according to claim 1, wherein said driving battery is connected to an on-board electrical system and an on-board battery via said controllable DC-DC converter.

3. The hybrid drive train according claim 1, including a further drivable axle with an associated electric motor connectable to at least one of said driving battery and said short-circuit winding of said stator as required.

4. A method for controlling a drive train, the method which comprises:
providing a hybrid drive train having an internal combustion engine, an electromagnetic transmission downstream of the internal combustion engine and an axle drive downstream of the electromagnetic transmission, the electromagnetic transmission including a housing, a first electric machine disposed in the housing, a second electric machine disposed in the housing, and a stator provided in common for the first electric machine and the second electric machine, the first electric machine having a rotatably mounted drive rotor connected to an input shaft and being operable predominantly as a generator, the second electric machine having a rotatably mounted output drive rotor connected to an output shaft, the second electric machine being connected downstream of the first electric machine and being operable predominantly as an electric motor, the drive rotor and the output drive rotor having, axially adjacent to one another, in each case permanent magnets of alternately opposite polarity distributed circumferentially to form a cylindrical arrangement, the stator having at least one short-circuit winding disposed radially adjacent to the permanent magnets of the drive rotor and the output drive rotor, the stator being connected in a rotationally fixed manner to a housing component and mounted in an axially displaceable manner, so that an effective transmission ratio can be set by an axial displacement of the stator in relation to the drive rotor and the output drive rotor;
providing a driving battery connected to the short-circuit winding via switchable lines and power electronics having an associated controllable DC-DC converter;
controlling a flow of energy between the first and second electric machines and the driving battery with a controller;
displacing the stator fully into or onto the drive rotor and operating the drive rotor in conjunction with the short-circuit winding as an electric motor for an electric starting of the internal combustion engine at a vehicle standstill.

5. The method according to claim 4, which comprises initially placing the stator fully into or onto the drive rotor and subsequently displacing the stator in a direction towards the output drive rotor in order to drive off from a vehicle standstill, wherein the drive rotor is operated in conjunction with the short-circuit winding as a generator and the output drive rotor is operated in conjunction with the short-circuit winding as an electric motor.

6. The method according to claim 4, which comprises:
feeding energy from the driving battery to the short-circuit winding for boosting or for raising a load point of the internal combustion engine; and
displacing the stator in a direction towards the drive rotor in order to compensate a thus changed transmission ratio of the electromagnetic transmission.

7. The method according to claim 4, which comprises:
feeding energy from the short-circuit winding to the driving battery for recuperating or for lowering a load point of the internal combustion engine; and
displacing the stator in a direction towards the output drive rotor in order to compensate a thus changed transmission ratio of the electromagnetic transmission.

8. The method according to claim 4, which comprises:
displacing the stator fully into or onto the output drive rotor for driving electrically when the internal combustion engine is turned off; and
subsequently operating the output drive rotor in conjunction with the short-circuit winding as an electric motor.

9. The method according to claim 4, which comprises charging the on-board battery via the controllable DC-DC converter as required from the driving battery or the short-circuit winding of the stator.

10. The method according to claim 4, which comprises connecting the driving battery to an on-board electrical system and an on-board battery via the controllable DC-DC converter.

11. The method according to claim 4, which comprises connecting an electric motor associated with a further drivable axle to at least one of the driving battery and the short-circuit winding of the stator as required.
